(19) United States
(12) Patent Application Publication
(10) Pub. No.: US 2007/0273826 A1
(43) Pub. Date: Nov. 29, 2007

(54) Lens mold assembly and optical lens made by it

(76) Inventor: Shen Zhi Chen, Tainan City (TW)

Correspondence Address: PRO-TECHTOR INTERNATIONAL SERVICES, 20775 NORADA CT., SARATOGA, CA, 95070, US

(21) Appl. No.: 11/716,955

(22) Filed: Mar. 12, 2007

(30) Foreign Application Priority Data
May 29, 2006 (TW) 095209243

(51) Int. Cl. G02C 7/10; B29C 33/56

(52) U.S. Cl. 351/163; 249/114.1

(57) ABSTRACT

A lens mold assembly and optical lens made by it. The lens mold assembly comprises: a lower mold, in each of four corners of the top surface of the lower mold is formed a protrusion, a polarizing film is disposed in an area defined by the four protrusions of the lower mold; and an upper mold, a space is defined between the bottom surface of the upper mold and a top surface of the lower mold, so that melted plastic material is poured into the space to form an optical lens after solidification. The polarizing film is attached to the optical lens at the right angle and position.

### BACKGROUND OF THE INVENTION

1. Field of the Invention

The present invention relates to a lens mold assembly and optical lens made by it, and more particularly to a technique of attaching polarizing film to the optical lens at the right angle and position.

2. Description of the Prior Art

Sunglasses lens is normally made of plastic material. Initially the plastic material is preformed into a predetermined shape with desired curvature and thickness, and then the outer surface of the plastic lens is treated with vacuum coating or tinting treatment to form a light shielding layer, and finally the plastic lens formed with the light shielding layer is cut into desired shape and size for fitting into spectacles frame.

In fact, however, the light shielding effect of the abovementioned light shielding layer is not good, it can't provide enough protection against sunlight, so wears still feel uncomfortably dazzling when wearing the sunglasses.

The present invention has arisen to mitigate and/or obviate the afore-described disadvantages.

### SUMMARY OF THE INVENTION

The primary objective of the present invention is to provide a lens mold assembly and optical lens made by it. The lens mold assembly comprises: a lower mold, in each of four corners of the top surface of the lower mold is formed a protrusion, a polarizing film is disposed in an area defined by the four protrusions of the lower mold; and an upper mold, a space is defined between the bottom surface of the upper mold and a top surface of the lower mold, so that melted plastic material is poured into the space to form an optical lens after solidification. The polarizing film is attached to the optical lens at the right angle and position, and consequently improving the acceptance rate.

A plurality of pushing pins is extended downward from a bottom surface of the upper mold and serve to press against the polarizing film to prevent any undesired displacement of the polarizing film.

The outer surface of the optical lens is attached with polarizing film to improve the polarizing and light shielding effect of the optical lens.

### BRIEF DESCRIPTION OF THE DRAWINGS

FIG. 1 is an exploded view of a lens mold assembly in accordance with the present invention;

FIG. 2 is a cross sectional view of the lens mold assembly in accordance with the present invention;

FIG. 3 is a perspective view of an optical lens with polarizing film in accordance with the present invention;

FIG. 4 is a perspective view of an optical lens without polarizing film in accordance with the present invention;

FIG. 5 is a plan view of the optical lens without polarizing film in accordance with the present invention; and

FIG. 6 is another plan view of the optical lens without polarizing film in accordance with the present invention.

### DETAILED DESCRIPTION OF THE PREFERRED EMBODIMENT

The present invention will be more clear from the following description when viewed together with the accompanying drawings, which show, for purpose of illustrations only, the preferred embodiment in accordance with the present invention.

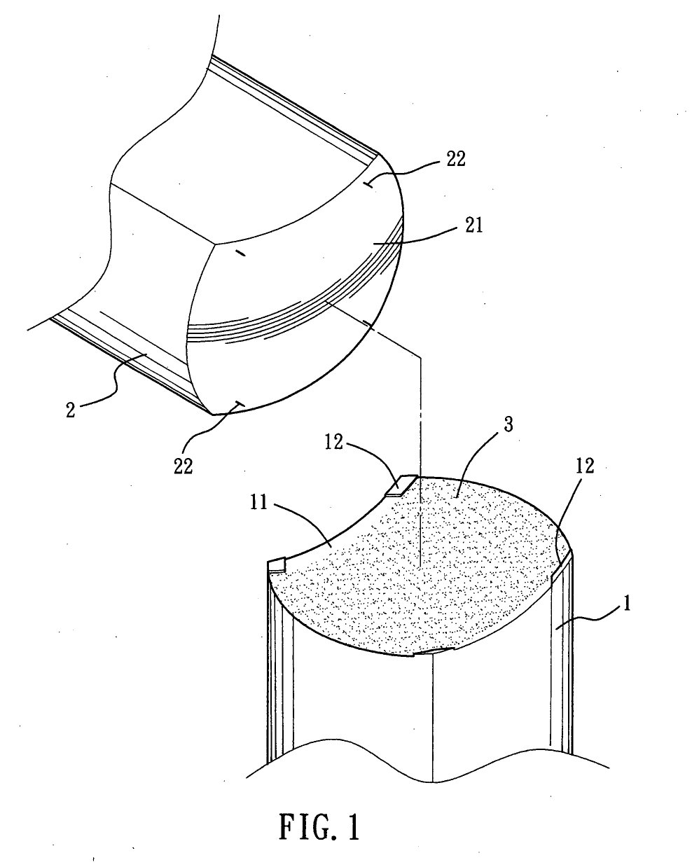

Referring to FIG. 1, a lens mold assembly in accordance with the present invention comprises: a lower mold I and an upper mold 2. A top surface 11 of the lower mold 1 is concave arc-shaped, in each of four corners of the top surface 11 is formed a protrusion 12, and a polarizing film 3 is disposed in an area defined by the four protrusions 12 in such a manner that the polarizing film 3 is closely stuck onto the top surface 11 of the lower mold 1 and is stopped by the four protrusions 12, so that the polarizing film 3 is firmly positioned on the top surface 11. The bottom surface 21 of the upper mold 2 is also concave arc-shaped to match the top surface 11 of the lower mold 1, and a plurality of pushing pins 22 extend downward from the bottom surface 21.

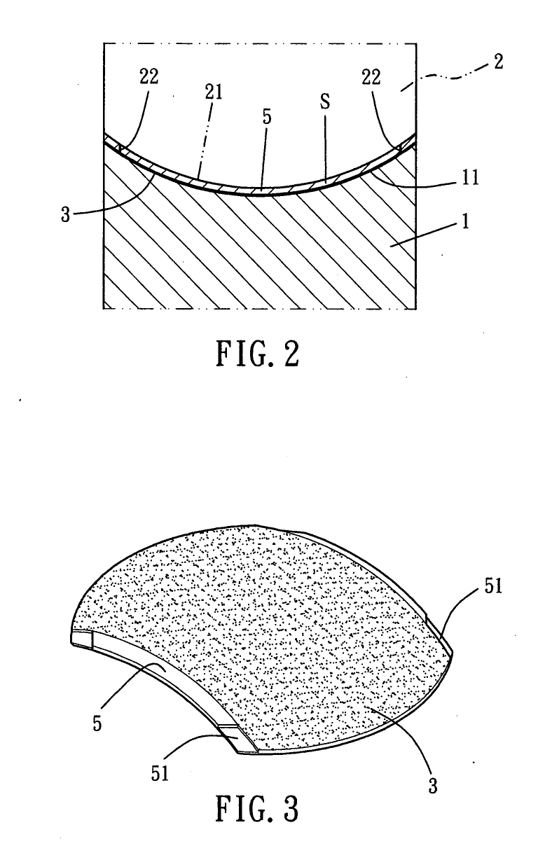

When the upper and lower molds 1, 2 are close to each other, the plurality of the pushing pins 22 press the polarizing film 3 downward, thus enabling the polarizing film 3 to be positioned more firmly and creating a space S between the top surface 11 and the bottom surface 21, as shown FIG. 2, so that melted plastic material is poured into the space S and forms an optical lens 5 after solidification, as shown in FIG. 3. In each of four corners of the outer surface of the optical lens 5 is defined a concave 51 corresponding to the protrusions 12 of the lower mold 1. Since the plastic material in a melted state has a strong adhesive force, after solidification, the polarizing film 3 will be naturally stuck to the surface of the optical lens 5 and located in the area defined by the four concaves 51 of the optical lens 5.

During the process of sticking the polarizing film 3 to the optical lens 5, the polarizing film 3 is firmly fixed by the four protrusions 12 and a plurality of pushing pins 22, so that it can be prevented from being interfered with and moved by the melted plastic material poured. Therefore, the polarizing film 3 is attached to the optical lens 5 at the right angle and position, and consequently improving the acceptance rate.

The optical lens 5 with the polarizing film 3 is then cut into a predetermined shape and size for fitting into the spectacles frame. The polarizing film 3 provides an optimum polarizing and light-shielding effect, reduces glare and protects the wearer eyes from being damaged by the sunlight.

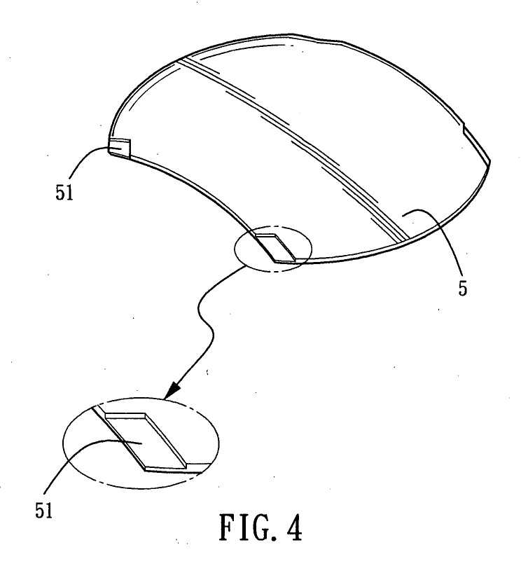

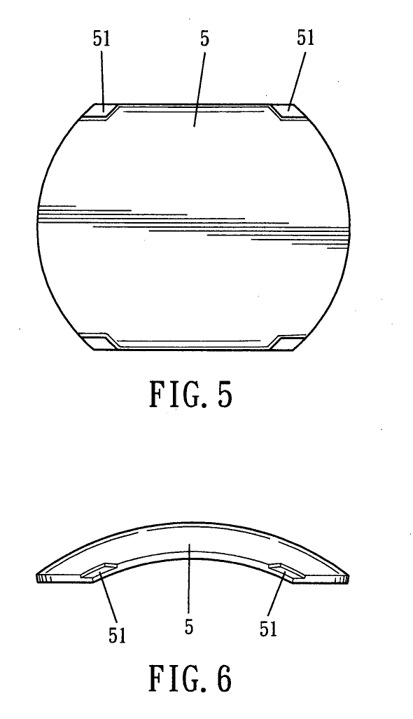

FIGS. 4, 5 and 6 show the optical lens 5 without polarizing film 3.

While we have shown and described various embodiments in accordance with the present invention, it is clear to those skilled in the art that further embodiments may be made without departing from the scope of the present invention.

What is claimed is:

1. An optical lens being formed at each of four corners of an outer surface thereof with a concave, and a polarizing film being stuck onto the optical lens and located in an area defined by the four concaves.

2. The optical lens as claimed in claim 1 is made of plastic material.

3. A lens mold assembly comprising:
a lower mold, in each of four corners of a top surface of the lower mold being formed a protrusion;
a polarizing film disposed in an area defined by the four protrusions of the lower mold; and
an upper mold, a plurality of pushing pins being extended downward from a bottom surface of the upper mold and serving to press against the polarizing film, a space being defined between the bottom surface of the upper mold and a top surface of the lower mold, so that melted plastic material is poured into the space.

4. The lens mold assembly as claimed in claim 3, wherein the top surface of the lower mold is concave arc-shaped, and the bottom surface of the upper mold is concave arc-shaped to match the top surface of the lower mold.
